(19) United States
(12) Patent Application Publication
(10) Pub. No.: US 2017/0214177 A1
(43) Pub. Date: Jul. 27, 2017

(54) CARD CONNECTOR AND MOBILE TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Xiangxin HUANG, Beijing (CN)

(21) Appl. No.: 15/241,392

(22) Filed: Aug. 19, 2016

Related U.S. Application Data
(63) Continuation of application No. PCT/CN2016/088151, filed on Jul. 1, 2016.

(30) Foreign Application Priority Data
Jan. 27, 2016 (CN) 201620082224.6

(51) Int. Cl. H01R 13/629; H01R 12/72

(52) U.S. Cl. CPC H01R 13/629; H01R 12/721

(57) ABSTRACT

The present disclosure relates to the field of mobile terminals, and in particular, to a card connector for a SIM card or a memory card, and a mobile terminal. The present disclosure discloses a card connector, which comprises a slot for pushing in or pulling out a card holder, wherein a width of an upper end of a cross section of the slot is larger than a width of a lower end thereof. The present disclosure further discloses a mobile terminal that comprises the card connector. In the card connector of the present disclosure, the slot has the cross section in the form of an inverted Chinese character “ [symbol] ” of which the upper end is wider than the lower end, and this can prevent the card holder from being reversely inserted, which may destroy the internal structure of the card connector.

### CROSS-REFERENCE TO RELATED APPLICATIONS

This application is a continuation of International PCT Patent Application No. PCT/CN2016/088151, filed Jul. 1, 2016 (attached hereto as an Appendix), and claims benefit/priority of Chinese patent application entitled “A CARD CONNECTOR AND MOBILE TERMINAL”, application number 201620082224.6, filed with the State Intellectual Property Office of China on Jan. 27, 2016, which are all incorporated herein by reference in entirety.

### TECHNICAL FIELD

The present disclosure relates to the technical field of mobile terminals, and in particular, to a card connector for a SIM card or a memory card, and a mobile terminal.

### BACKGROUND

At present, mobile terminals tend to be lighter and thinner. By a drawer-type card holder design, the thickness of a mobile terminal can be decreased, and at the same time, a SIM card or a memory card can be taken out without the need to open the back cover of the mobile terminal. A SIM card or a memory card is placed inside a card holder that can be detached from the mobile terminal, then it is inserted into a card connector of the mobile terminal along with the card holder; when the SIM card or the memory card needs to be taken out, a spring is triggered to pop out the card holder by inserting a card needle into a pinhole. The card connector does not have an anti plug design, as a result, when the card holder is inserted into the card connector in the mobile terminal body, the inverted insertion of the card holder into the card connector will damage the internal structure of the card connector.

### SUMMARY

Therefore, it is an object of the present disclosure to provide a card connector, wherein, a slot of the card connector has a cross section in the form of an inverted Chinese character “ [symbol] ” of which a upper end is wider than a lower end, thereby the card holder may be prevented from being reversely inserted, which will damage the internal structure of the card connector.

According to one aspect of the present disclosure, there provides a card connector, which has a slot for pushing in or pulling out a card holder, wherein a width of an upper end of a cross section of the slot is larger than a width of a lower end thereof.

Optionally, the lower end of the cross section of the slot is recessed inwardly along its width direction.

Optionally, the width of the lower end of the cross section of the slot is smaller than a width of an upper part of a cross section of the card holder.

Optionally, the width of the lower end of the cross section of the slot is larger than a distance between outer side surfaces of two guide edges of a lower part of the cross section of the card holder.

Optionally, the width of the upper end of the cross section of the slot is larger than the width of the upper part of the cross section of the card holder.

Optionally, the cross section of the slot has a structure in the form of an inverted Chinese character “ [symbol] ”.

Optionally, a vertex angle on at least one side of the lower end of the cross section of the slot is a right angle or an arc angle.

In another aspect of the present disclosure, there provides a mobile terminal, which includes the above card connector.

By employing the slot according to the present disclosure that has the cross section of which the upper end is wider than the lower end, reverse insertion that will damage the internal structure of the card connector can be avoided.

It should be understood that, the above general description and the following detailed description are exemplary and illustrative only, without limiting the scope of the present disclosure.

### BRIEF DESCRIPTION OF THE DRAWINGS

The exemplary description, which can not constitute a limit for the embodiments of one or more embodiments is given according to the figures of the corresponding appended drawings in which like reference numbers identify like elements. Unless otherwise specified, the figures of the appended drawings do not impose restrictions on the proportion.

FIG. 1 is a front view showing a sectional structure of the prior art in which a card holder is correctly inserted into a card connector;

FIG. 2 is a front view showing a sectional structure of the prior art in which a card holder is reversely inserted into a card connector;

FIG. 3 is a front view showing a sectional structure of a first embodiment of the present disclosure in which a card holder is correctly inserted into a card connector; and

FIG. 4 is a front view showing a sectional structure of a first embodiment of the present disclosure in which a card holder is reversely inserted into a card connector.

### DETAILED DESCRIPTION

Exemplary embodiments will be illustrated in detail here, the examples of which are shown in the drawings. When the description below relates to the drawings, the same number in different drawings represents the same or similar element, unless otherwise expressed. The implementation modes described in the exemplary embodiments below do not represent all the implementation modes consistent with the present disclosure. On the contrary, they are only examples of the devices and methods consistent with some aspects of the present disclosure that are described in detail in the claims appended.

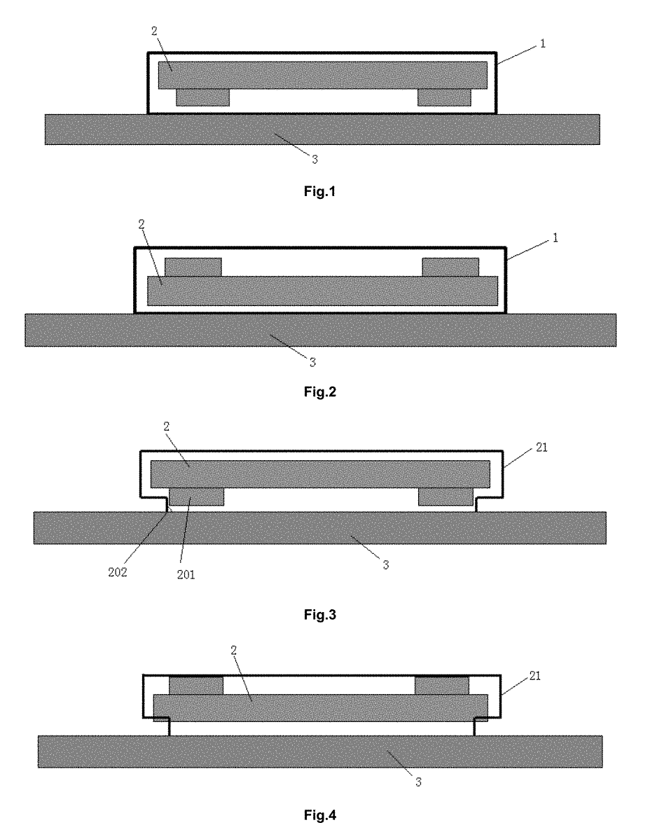

In the prior art, as shown in FIG. 1, a cross section of a slot 1 of a card connector of a mobile terminal has a rectangular structure. When a card holder 2 is correctly inserted, a SIM card or a memory card can be made well contact the card connector of the mobile terminal. As shown in FIG. 2, when the card holder 2 is reversely inserted, the card holder 2 can also enter the slot 1 of the card connector of the mobile terminal, but the internal structure of the card connector will be damaged.

As shown in FIG. 3, it is a front view showing a sectional structure of a first embodiment of the present disclosure in which a card holder is correctly inserted into a card connector. The card connector according to the present disclosure includes a slot 21, which has a cross section in the form of an inverted Chinese character “ [symbol] ” of which an upper end is wider than a lower end. The lower end of the slot 21 is connected with a PCB board 3, and the depth of the slot 21 matches the card holder.

The lower end of the cross section of the slot 21 is recessed inwardly along its width direction; as shown in FIG. 3, the slot 21 is recessed inwardly along its width direction at a position where it is connected with the PCB board 3. As a preferred embodiment of the present disclosure, the width of the lower end of the cross section of the slot 21 is smaller than a width of an upper part of a cross section of the card holder 2, and/or the width of the lower end of the cross section of the slot 21 is larger than a distance between outer side surfaces of two guide edges 201 of a lower part of the cross section of the card holder 2. Wherein, the width of the lower end of the cross section of the slot 21 is a distance between a right side and a left side of the lower end of the cross section of the slot 21, and the width of the upper part of the cross section of the card holder 2 is a distance between a right side and a left side of the upper part of the cross section of the card holder 2. The guide edges 201 of the card holder 2 correspond to guide slots of the connector, thereby a location of the card holder 2 in the mobile terminal can be positioned more accurately.

The width of the upper end of the cross section of the slot 21 is larger than the width of the upper part of the cross section of the card holder 2. Wherein, the width of the upper end of the cross section of the slot 21 is a distance between a right side and a left side of the upper end of the slot 21.

As shown in FIG. 3, as a preferred embodiment of the present disclosure, a vertex angles 202 on the lower end of the slot 21 are right angles, wherein the vertex angles on the lower ends are angles formed inside of the slot 21 by connecting the lower ends with the PCB board. However, the vertex angle on the lower end may also be an arc angle.

When the card holder 2 is correctly inserted, the structure of the cross section of the slot 21 of which the upper end is wider than the lower end can make a SIM card or a memory card well contact the card connector of the mobile terminal. As shown in FIG. 4, when the card holder 2 is reversely inserted, it cannot be inserted into the slot 21 of the connector.

In conclusion, by employing the slot according to the present disclosure that has the cross section of which the upper end is wider than the lower end, reverse insertion that will damage the internal structure of the card connector can be avoided.

Finally, it should be noted that the examples as described above are only for the purpose of illustrating the technical solution of the present disclosure, without limiting the scope thereof. Although the present disclosure have been described according to the previous examples, the person skilled in the art will appreciate that various modifications to the solution recorded in the respective examples and equivalent substitutions for part of the features are possible, without departing from the scope and spirit of the technical solution of the examples of the present disclosure.

1. A card connector, comprising:
a slot for pushing in or pulling out a card holder,
wherein a width of an upper end of a first cross section of the slot is larger than a width of a lower end of the cross section of the slot.

2. The card connector according to claim 1, wherein the lower end of the cross section of the slot is recessed inwardly along its width direction.

3. The card connector according to claim 1, wherein the width of the lower end of the cross section of the slot is smaller than a width of an upper part of a cross section of the card holder.

4. The card connector according to claim 3, wherein the width of the lower end of the cross section of the slot is larger than a distance between outer side surfaces of two guide edges of a lower part of the cross section of the card holder.

5. The card connector according to claim 1, wherein the width of the upper end of the cross section of the slot is larger than the width of the upper part of the cross section of the card holder.

6. The card connector according to claim 1, wherein the cross section of the slot has a structure in the form of an inverted shape of “ [symbol] ”.

7. The card connector according to claim 1, wherein a vertex angle on at least one side of the lower end of the cross section of the slot is a right angle or an arc angle.

8. (canceled)

9. The card connector according to claim 2, wherein the width of the upper end of the cross section of the slot is larger than the width of the upper part of the cross section of the card holder.

10. The card connector according to claim 3, wherein the width of the upper end of the cross section of the slot is larger than the width of the upper part of the cross section of the card holder.

11. The card connector according to claim 4, wherein the width of the upper end of the cross section of the slot is larger than the width of the upper part of the cross section of the card holder.

12. The card connector according to claim 2, wherein the cross section of the slot has a structure in the form of an inverted shape of “ [symbol] ”.

13. The card connector according to claim 3, wherein the cross section of the slot has a structure in the form of an inverted shape of “ [symbol] ”.

14. The card connector according to claim 4, wherein the cross section of the slot has a structure in the form of an inverted shape of “ [symbol] ”.

15. The card connector according to claim 2, wherein a vertex angle on at least one side of the lower end of the cross section of the slot is a right angle or an arc angle.

16. The card connector according to claim 3, wherein a vertex angle on at least one side of the lower end of the cross section of the slot is a right angle or an arc angle.

17. The card connector according to claim 4, wherein a vertex angle on at least one side of the lower end of the cross section of the slot is a right angle or an arc angle.

18. A mobile terminal, comprising:
a card connector, the card connector comprises a slot for pushing in or pulling out a card holder,
wherein a width of an upper end of a cross section of the slot is larger than a width of a lower end thereof.

19. The mobile terminal according to claim 18, wherein the lower end of the cross section of the slot is recessed inwardly along its width direction.

20. The mobile terminal according to claim 18, wherein, the width of the lower end of the cross section of the slot is smaller than a width of an upper part of a cross section of the card holder.

21. The mobile terminal according to claim 20, wherein, the width of the lower end of the cross section of the slot is larger than a distance between outer side surfaces of two guide edges of a lower part of the cross section of the card holder.
